(19) United States
(12) Patent Application Publication
(10) Pub. No.: US 2011/0000297 A1
(43) Pub. Date: Jan. 6, 2011

(54) FLUID TANK AND FLUID LEVEL SENDER WITH EXTERNAL SIGNALING FEATURE

(75) Inventor: David H. Ford, Canton, MI (US)

Correspondence Address: REISING ETHINGTON P.C., P O BOX 4390, TROY, MI, 48099-4390, US

(73) Assignee: TI Group Automotive Systems, L.L.C., Auburn Hills, MI (US)

(21) Appl. No.: 12/830,502

(22) Filed: Jul. 6, 2010

Related U.S. Application Data
(60) Provisional application No. 61/223,231, filed on Jul. 6, 2009.

(51) Int. Cl. G01F 23/32

(52) U.S. Cl. 73/313; 73/317

(57) ABSTRACT

A fluid level sender may include a sensing feature disposed within an internal volume of a tank, responsive to the level of liquid within the tank and including a drive member, a signaling feature disposed outside of the internal volume of the tank and including a driven member and a dividing wall. The dividing wall may be disposed between and separating the sensing feature from the signaling feature. The drive member provides a force and the driven member is responsive to the force provided from the drive member to enable the signaling feature to provide an indication of the amount of liquid within the tank.

### REFERENCE TO RELATED APPLICATION

This is a nonprovisional application that claims the benefit of, and incorporates by reference in its entirety, U.S. Provisional Application Ser. No. 61/223,231, filed on Jul. 6, 2009.

### TECHNICAL FIELD

The present disclosure relates generally to a fluid tank and a device for monitoring the level of fluid within the fluid tank.

### BACKGROUND

Fuel tanks for vehicles typically include a device for monitoring the level of fuel within the fuel tank, sometimes called a fuel level sender. The fuel level senders are mounted in the fuel tank, sometimes as part of a module including a fuel pump, through a hole in the tank which must subsequently be closed and sealed. The fuel level senders typically include a float and a wiper driven by the float relative to a printed resistor card to provide a variable resistance signal indicative of the position of the float and hence, the level of fluid within the tank. To access the fuel level sender, the seal must be broken and the entire assembly removed from the tank through the hole. This is true even if only part of the fuel level sender, for example the wiper and resistor card, needs to be serviced or replaced. Further, some of the components of a fuel level sender can become corroded or otherwise fouled when in contact with fuel or other liquids in a tank.

### SUMMARY

A fluid level sender may include a sensing feature disposed within an internal volume of a tank, responsive to the level of liquid within the tank and including a drive member, and a signaling feature disposed outside of the internal volume of the tank and including a driven member and a dividing wall. The dividing wall may be disposed between and separating the sensing feature from the signaling feature. The drive member provides a force and the driven member is responsive to the force provided from the drive member to enable the signaling feature to provide an indication of the amount of liquid within the tank.

A fluid tank assembly may include a fluid tank having a wall defining an internal volume in which a fluid is received and a fluid level sender. The fluid level sender may have a sensing feature disposed within an internal volume of a tank, responsive to the level of liquid within the tank and including a drive member, a signaling feature disposed outside of the internal volume of the tank, and a dividing wall disposed between and separating the sensing feature from the signaling feature. The sensing feature may include a drive member that provides a force capable of being sensed from outside of the internal volume of the tank and the signaling feature includes a driven member that is responsive to the force provided from the drive member to provide an indication of the amount of liquid within the tank.

### BRIEF DESCRIPTION OF THE DRAWINGS

The following detailed description of preferred embodiments and best mode will be set forth with reference to the accompanying drawings, in which:

FIG. 1 is a fragmentary, perspective, sectional view of a portion of a fluid tank with one implementation of an exemplary fluid level sender mounted on the fluid tank;

FIG. 2 is an perspective view of the fluid level sender of FIG. 1;

FIG. 3 is an enlarged, fragmentary view of a portion of the fluid level sender within the circle 3 in FIG. 2;

FIG. 4 is an enlarged, fragmentary sectional view of a portion of a fuel tank wall; and

FIG. 5 is a fragmentary sectional view of a portion of a fluid tank with an alternate fluid level sender mounted on the fluid tank.

### DETAILED DESCRIPTION OF PRESENTLY PREFERRED EMBODIMENTS

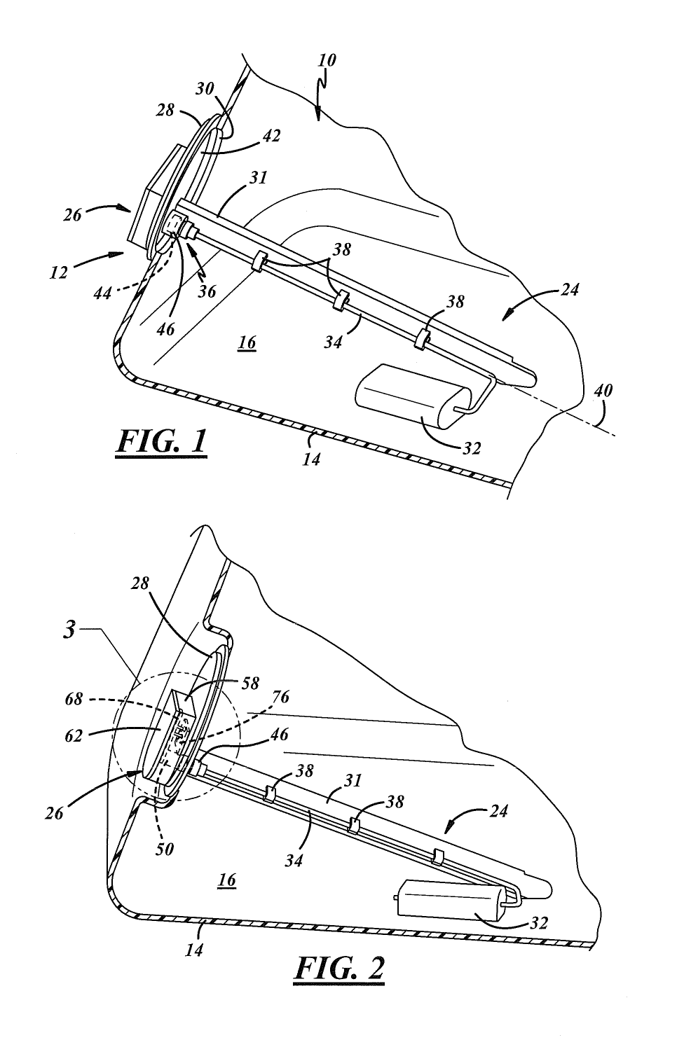

Referring in more detail to the drawings, FIG. 1 illustrates a fluid tank 10, such as fuel tank that may be used to retain a supply of liquid fuel in a fuel system, and a sensor or fluid level sender 12 associated with the tank. Such fuel systems may be used, for example, in automotive applications to deliver fuel for combustion within an engine. The fluid level sender 12 may be used to monitor and provide a signal indicative of the level of fluid (fuel) in the tank 10. Of course, the tank 10 and fluid level sender 12 may be used with fluids other than fuel and in applications other than vehicle fuel systems.

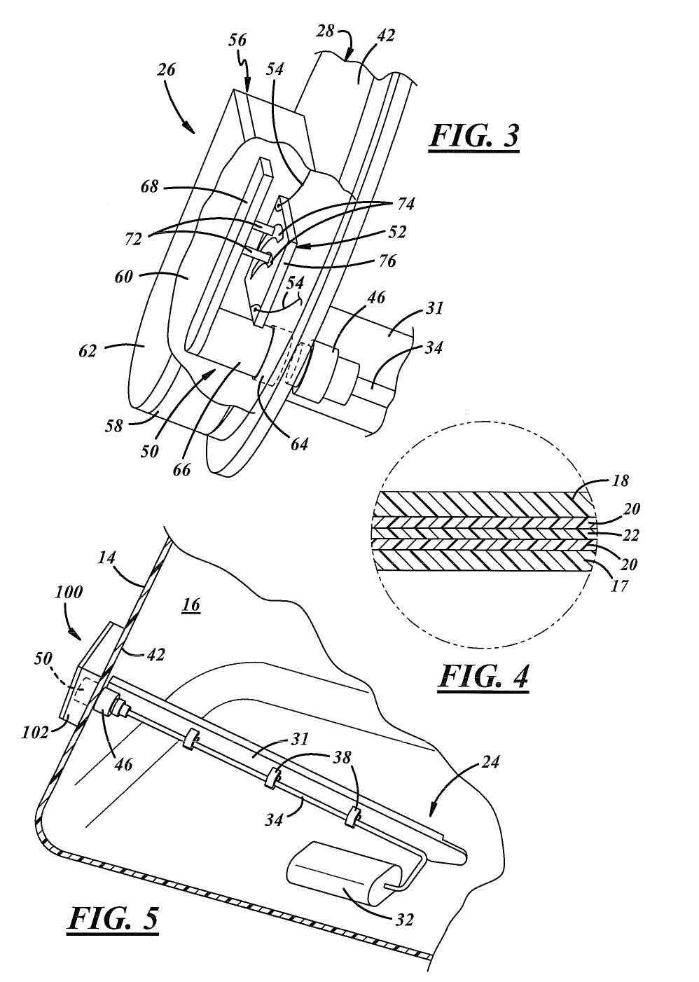

The fuel tank 10 may include one or more walls 14 defining an internal volume 16 in which the fluid is contained. The fuel tank wall(s) 14 may be formed of any suitable metal or non-metallic material. In one form, the fuel tank 10 may be formed from several layers of polymeric materials, in a so-called “multi-layer” fuel tank. As shown in FIG. 4, the various layers may include one or more structural layers which may form inner and outer layers 17, 18 formed of HDPE or the like, one or more adhesive layers 20 and one of more barrier layers 22 having a desired resistance to permeation therethrough of hydrocarbon or other vapors or liquids associated with the fluid contained within the fuel tank 10. Exemplary barrier layer materials include nylons and EVOH (ethylene vinyl alcohol), although others may be used. Alternatively, the tank 10 could be formed from a single material, or could have layers in addition to or other than those specifically noted herein.

In one implementation, the fluid level sender 12 may include a sensing feature 24, a signaling feature 26, and a mounting flange 28. The mounting flange 28 may be sealed to the fuel tank 10 about an opening 30 through the fuel tank wall 14, to close the opening 30 and mount the fluid level sender 12 on the tank. The mounting flange 28 may be formed of the same material(s) as the fuel tank 10, or of any other suitable material. A support 31 may extend from the mounting flange 28 and into the internal volume 16 of the fuel tank 10. The sensing feature 24 may be disposed within the internal volume 16 of the tank 10. The signaling feature 26 may be communicated with the sensing feature 24 and maintained separate from and outside of the internal volume 16 of the fuel tank 10. In this way, the signaling feature 26 may be maintained separate from and not in contact with the liquid within the tank 10, and the mounting flange 28 serves as a dividing wall between the sensing and signaling features 24, 26.

In one implementation, the sensing feature 24 includes a float 32, a float arm 34 coupled to the float 32 and a drive member 36 coupled to the float arm 34. The float 32 may be formed of any suitable material adapted to float on the surface of the fluid contained within the tank 10. The float arm 34 may be a rod of any suitable material for use in contact with the liquid in the tank 10. The float arm 34 may be held by the support 31 that is carried by the mounting flange 28 or by the fuel tank 10. The float arm 34 may be clipped to the support 31 in a manner permitting rotation of the float arm 34 relative to the support. In one form, the support 31 may include outwardly extending tabs 38 and the float arm 34 may be snap-fit or otherwise disposed underneath and retained by the tabs 38. The tabs 38 may be oriented in different directions or at different angles to more securely retain the float arm 34 and resist unintended removal of the float arm 34 from the support 31. To permit the float 32 to move in accordance with changes in the surface level of the liquid in the tank 10, the float arm 34 may be bent. Accordingly, as the float 32 is raised and lowered in response to changes in the surface level of the liquid in the tank 10, the float arm 34 is rotated relative to the support 31 and about an axis 40 of the portion of the float arm 34 coupled to the support 31.

The drive member 36 may be coupled to the float arm 34 for co-rotation with the float arm 34. The drive member 36 may provide a force or other output capable of being sensed through a dividing wall 42 disposed between the sensing feature 24 and the signaling feature 26. In at least some implementations, the dividing wall 42 (which may be a portion of the tank wall as will be set forth below) may be up to about 5 mm in total thickness, and in some implementations, the dividing wall may be between about 2 mm to 4 mm in total thickness. For example, the wall across or through which the fluid level sender 12 operates may be composed of any suitable polymeric material, for example, polyamide or NYLON 6/6, or a metal such as a stainless steel that is sufficiently non-magnetic or is sufficiently magnetically permeable, for example austenitic or nickel containing stainless steel.

In one form, the drive member 36 includes at least one magnet 44 carried by the support 31 or the float arm 34 and rotatable with the float arm 34. The magnet 44 may be received within a housing 46 that is coupled to the float arm 34, and may be molded or pressed onto, or otherwise connected to the float arm. The magnet 44 provides a magnetic field that rotates as the float arm 34 and magnet 44 are rotated by movement of the float 32. The drive member 36 may be constructed and composed of one or more rare-earth magnets carried in a stainless steel housing, or overmolded with phenolic or polyphenylene sulfide (PPS) resin. The magnets 44 may be composed, for example, of neodymium, iron, and boron (Nd₂Fe₁₄B). In another example, the drive member 36 may be commercially available from Magnetic Technologies, Ltd. of Oxford, Mass. An exemplary coupling is an MTD-0.2 ASSY having 0.2 Nm of slip torque and constructed with an aluminum housing and two or more magnets. The housing 46 and magnets 44 rotate with the float arm 34 as the position or level of the float 32 changes.

The signaling feature 26 may be disposed on the opposite side of the dividing wall 42 (e.g. flange 28) as the sensing feature 24 so that, if desired, the signaling feature 26 may be maintained outside of and separate from the internal volume 16 of the tank 10. As shown in FIGS. 2 and 3, the signaling feature 26 may include a driven member 50, a signal generating feature 52 and a signal output 54. These components may be provided within a housing 56 that may be carried by, or defined at least in part by, or formed in one-piece with the flange 28. In the implementation shown in FIG. 1, the flange 28 includes a wall 58 defining a cavity or receptacle 60 in which the driven member 50, signal generating feature 52 and signal output 54 may be received. A cover 62 may be connected to the flange 28 or its wall 58, to enclose the receptacle 60 and protect the signaling feature components.

The driven member 50 may include a magnet 64 or a magnetically responsive member communicated with the drive member 36 through the dividing wall, which, is shown here as part of the mounting flange 28. Accordingly, in the implementation shown, the driven member 50 is rotated as the drive member 36 rotates. Of course, the driven member 50 may be driven for movement other than rotation, or in addition to rotation, in response to movement of the drive member 36. The magnet 64 may be carried by a body 66 that is supported for rotation within the receptacle 60. The body 66 may include an arm 68 extending generally outwardly or radially relative to an axis of rotation 70 of the driven member 50. The arm 68 may include one or more contacts 72 adapted to be moved relative to one or more resistive arrays 74 on a card 76. The position of the contact(s) 72 relative to the resistive array(s) 74 can provide a varying resistance within a circuit to enable determination of the level of fluid within the tank 10 as a function of the detected resistance in the circuit. The resistance card 76 may be constructed and arranged in any suitable fashion, including as set forth in U.S. Pat. No. 7,091,819. The resistive signal may be a function of the position of arm 68 and contacts 72, which is a function of the position of the driven member 50, which is a function of the position of the drive member 36, which is a function of the position of the float 32 which is a function of the fluid level within the tank 10. A signal indicative of the fuel level in the fuel tank may be provided by the output 54 which may consist of one or more wires coupled to the card 76 (as shown in FIG. 3), a wireless transmitter or other suitable arrangement.

Instead of the pivoted or rotated arm 34 and the resistive card arrangement, the driven member could be of any other suitable construction and arrangement, including, for example, a hall-effect sensor, magneto-resistive sensor, a reed-switch type of device, or any other device that when mounted outside of a dividing wall 28 is capable of being coupled, such as magnetically, to a level sensor 24 disposed on an opposite side of the dividing wall 28. In this manner, the driven member 50 may be responsive to but not necessarily moved by the magnetic field. Known sensor types such as those noted above can sense magnetic field strength (hence, relative proximity of a magnet), magnetic field direction or orientation, and/or the pressure of a magnetic field.

The poles of the magnets 44, 64 of the drive and driven members 36, 50 may be arranged to cooperate and provide movement of the driven member 50 in response to movement of the drive member 36. In other words, in an implementation where the drive member 36 is rotated as the fluid level in the tank changes, then the magnets 44, 64 are arranged so that magnetic field of the rotating drive member 36 causes a corresponding movement (e.g. rotation) of the driven member 50. In some implementations, the driven member 50 need not include a magnet 64. Instead, the driven member 50 could include a sensor which senses, for example, the magnitude of the magnetic field provided by the drive member magnet(s) 44 (or the proximity of the magnets 44 to the sensor). The proximity of the drive member magnets 44 to the sensor may change in an implementation where the drive member 36 is moved toward and away from the dividing wall and driven member rather than rotated. Or the driven member 50 could be responsive to the rotary position of the magnets 44 which may, for example, be determined by sensing the rotation of the magnetic field as the drive member 36 rotates.

By positioning the signaling feature 26 separate from and outside of the tank 10, the signaling feature 26 can be accessed, repaired or replaced within having to enter the internal volume 16 of the tank 10. This can greatly decrease the time and cost to repair or replace the signaling feature 26. Also, the signaling feature 26 can be isolated from and not in contact with the liquid within the tank 10. This could permit less expensive materials to be used in the signaling feature 26, and can prevent corrosion, fouling or other damage to the signaling feature 26 such as may be caused by some liquids like liquid fuel or gasoline used in internal combustion engines. In one form, the driven member may include a magnet and the drive member may include a ferromagnetic material to which the magnet is attracted. Accordingly, movement of the ferromagnetic drive member may induce or cause movement of the driven member.

As best shown in FIG. 5, the signaling feature 100 could be provided on the tank wall 14, rather than on a mounting flange. In this implementation, no opening is needed through the tank wall 14, and a portion of the tank wall 14 may define the dividing wall 42 that separates the sensing feature 24 and signaling feature 26. The sensing feature 24 could be installed into the tank 10 through a separate opening provided for another component (for example, a pump or a filler neck through which fluid is added to the tank), or during forming of the tank when an opening, which is later closed, exists in the material from which the tank is made (e.g. the tank could be made from more than one piece of material welded together, or the tank could be molded from a parison of material that initially includes an opening in which components can be installed before final molding of the fuel tank). And the signaling feature 26 could be mounted to the tank 10, either within a receptacle 102 carried by or formed on the tank 10, or otherwise.

In use, the sensing feature 24 is responsive to the liquid level within the tank 10, and drives the signaling feature 26 as a function of the liquid level. The signaling feature 26 then provides an output, either through suitable wires or wirelessly transmitted, to a receiver or other device. The receiver or other device may provide a visual display or other presentation of the liquid level within the tank 10, to alert or inform an operator or user of the liquid level remaining in the tank 10.

Accordingly, the fluid level sender may be provided in a wide range of locations and orientations relative to the tank. The signaling feature 26, driven member 50 and related components can be removed from the tank 10 without having to access the internal volume 16 of the tank 10 or break any seals of the tank. And the signaling feature 26, driven member 50 and related components can be serviced or replaced, without having to move, replace or disturb the sensing feature 24. This greatly improves the ease of servicing and maintaining the fluid level sender 12 because in many applications the signaling feature 26 and related components and circuitry are the components most likely to become fouled, corroded or otherwise fail in service, and these components may be easily accessed from outside of the tank.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A fluid level sender, comprising:
a sensing feature disposed within an internal volume of a tank, responsive to the level of liquid within the tank and including a drive member;
a signaling feature disposed outside of the internal volume of the tank and including a driven member; and
a dividing wall disposed between and separating the sensing feature from the signaling feature;
wherein the drive member provides a force and the driven member is responsive to the force provided from the drive member to enable the signaling feature to provide an indication of the amount of liquid within the tank.

2. The fluid level sender of claim 1, wherein the drive member includes a magnet and the force provided by the drive member is a magnetic field.

3. The fluid level sender of claim 2 wherein the drive member is rotated as the liquid level within the tank changes, and the driven member is responsive to rotation of the drive member.

4. The fluid level sender of claim 2 wherein the driven member is magnetically coupled to the drive member.

5. The fluid level sender of claim 1 wherein the dividing wall is a mounting flange adapted to be coupled to the tank and on which the sensing feature and signaling feature are carried.

6. The fluid level sender of claim 1 wherein the dividing wall is a portion of a wall of the tank.

7. The fluid level sender of claim 1 wherein the sensing feature includes a float that is responsive to changes in the level of fluid within the tank.

8. The fluid level sender of claim 7 wherein the sensing feature includes a float arm to which the float and the drive member are connected, and wherein the float arm and drive member are rotated about an axis as the float moves vertically due to a changing level of fluid within the tank.

9. The fluid level sender of claim 8 wherein the axis about which the float arm is rotated is parallel to a portion of the float arm to which the drive member is connected.

10. The fluid level sender of claim 8 which also includes a support and wherein the float arm is connected to the support in a manner permitting rotation of the float arm relative to the support.

11. The fluid level sender of claim 1 wherein the signaling feature includes a signal generating feature coupled to the driven member and responsive to movement of the driven member, and a signal output to provide a signal indicative of the fluid level in the fluid tank.

12. The fluid level sender of claim 11 wherein the signal generating feature includes a variable resistive element that provides a varying resistance within a circuit as a function of the position of the driven member.

13. The fluid level sender of claim 12 wherein the variable resistive element includes a contact coupled to the driven member for movement with the driven member and a resistive array engaged by the contact.

14. The fluid level sender of claim 2 wherein the driven member is a sensor that is responsive to the magnetic field of the drive member.

15. A fluid tank assembly, comprising:
a fluid tank having a wall defining an internal volume in which a fluid is received;
a fluid level sender having:
a sensing feature disposed within an internal volume of a tank, responsive to the level of liquid within the tank and including a drive member;
a signaling feature disposed outside of the internal volume of the tank; and
a dividing wall disposed between and separating the sensing feature from the signaling feature;
wherein the sensing feature includes a drive member that provides a force capable of being sensed from outside of the internal volume of the tank and the signaling feature includes a driven member that is responsive to the force provided from the drive member to provide an indication of the amount of liquid within the tank.

16. The fluid tank assembly of claim 15, wherein the dividing wall is a portion of a wall defining the internal volume.

17. The fluid tank assembly of claim 15 wherein the dividing wall is a separate structure from the fluid tank wall that is connected to the fluid tank wall.

18. The fluid level sender of claim 15, wherein the drive member includes a magnet and the force provided by the drive member is a magnetic field.

19. The fluid level sender of claim 18 wherein the drive member is rotated as the liquid level within the tank changes, and the driven member is responsive to rotation of the drive member.

20. The fluid level sender of claim 15 wherein the sensing feature includes a float that is responsive to changes in the level of fluid within the tank, a float arm to which the float and the drive member are connected, and wherein the float arm and drive member are rotated about an axis as the float moves due to a changing level of fluid within the tank.

21. The fluid level sender of claim 15 wherein the signaling feature includes a signal generating feature coupled to the driven member and responsive to movement of the driven member, and a signal output to provide a signal indicative of the fluid level in the fluid tank.

22. The fluid level sender of claim 21 wherein the signal generating feature includes a variable resistive element that provides a varying resistance within a circuit as a function of the position of the driven member.

23. The fluid level sender of claim 22 wherein the variable resistive element includes a contact coupled to the driven member for movement with the driven member and a resistive array engaged by the contact.

24. The fluid level sender of claim 18 wherein the driven member is a sensor that is responsive to the magnetic field of the drive member.
